(19) United States
(12) Patent Application Publication
(10) Pub. No.: US 2008/0024370 A1
(43) Pub. Date: Jan. 31, 2008

(54) Device Comprising an Antenna For Exchanging Radio Frequency Signals

(75) Inventor: Anthony Kerselaers, Leuven (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,178

(22) PCT Filed: May 23, 2005
(86) PCT No.: PCT/IB05/51669

§ 371 Date: Nov. 16, 2006

(30) Foreign Application Priority Data
May 27, 2004 (EP) 04102347.4

(51) Int. Cl. H01Q 1/24

(52) U.S. Cl. 343/702

(57) ABSTRACT

Devices (1) comprising antennas (2) for exchanging radio frequency signals are provided with conductive planes (11,12) with slots (10) comprising open ends and closed ends. Connection points (13,14) are located near the slots (10) more closely to the closed ends than to the open ends. The conductive planes (11,12) do not operate against ground surfaces, to keep the antenna small. Perimeters of the conductive planes (11,12) are between 50% and 200% of a wavelength of the radio frequency signals, to get sufficient antenna performances and bandwidths. Radio modules (16) with conductive shieldings are mounted on non-conductive areas (15) of the conductive planes (11, 12), to exchange radio frequency signals in three directions. The lengths of the slots (10) are 10%-50% of the wavelength. A distance (d) from the connection point (13,14) to a nearest side of the conductive plane (11,12) in a direction perpendicular to the slot (10) at the closed end is at least 2% of the wavelength.

The invention relates to a device comprising an antenna for exchanging radio frequency signals with an other device, and also relates to an antenna, and to a method.

Examples of such a device are home theatre devices, surround sound devices, wireless headphone devices, second room wireless audio devices, bio-sensing devices, positioning tracking devices, mobile terminals and wireless interfaces.

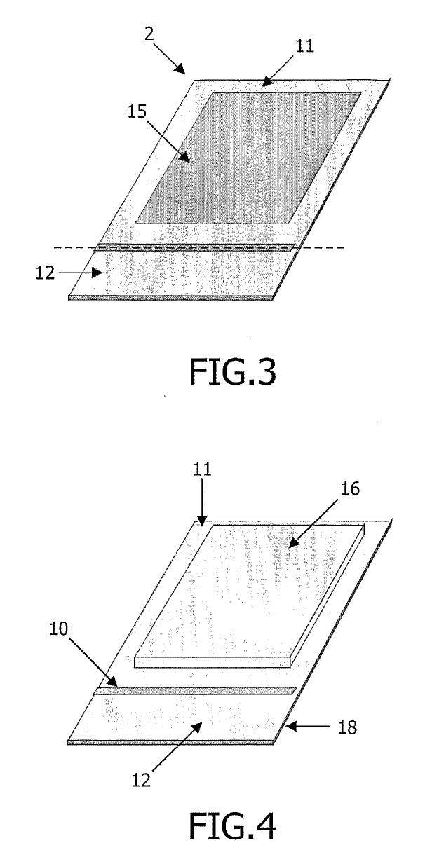

A prior art antenna is known from US 2002/0177416 A1, which discloses in its FIGS. 2 and 3 a ground surface comprising a RF module. This RF module comprises a ground plane incorporating a slot with an open end and a closed end. A connection point is located closer to the open end of the slot than to the closed end of the slot.

The known antenna is disadvantageous, inter alia, owing to the fact that the ground plane operates against the ground surface. Such a ground surface results in a sufficient antenna performance, but is relatively large.

It is an object of the invention, inter alia, to provide a device comprising a relatively small antenna having a sufficient antenna performance.

Furthers objects of the invention are, inter alia, to provide a relatively small antenna having a sufficient antenna performance, and a method for use in combination with a relatively small antenna having a sufficient antenna performance.

The device according to the invention comprises an antenna for exchanging radio frequency signals with an other device, which antenna comprises:

a conductive plane with a slot comprising an open end and a closed end; and

a connection point located near the slot more closely to the closed end than to the open end;

which conductive plane does not operate against a ground surface, the perimeter of the conductive plane being between 50% and 200% of a wavelength of the radio frequency signals.

By giving the conductive plane a perimeter between 50% and 200% of a wavelength of the radio frequency signals and by avoiding the conductive plane operating against a ground surface acting as a mirror, the antenna in the device according to the invention is relatively small and has a good antenna performance. Such a ground surface increases the antenna efficiency, but the antenna efficiency of the antenna of the device according to the invention is that good that the ground surface can be avoided. Because of not comprising a ground surface acting as a mirror, the antenna is relatively small. Preferably, the perimeter is about one wavelength.

This antenna is further advantageous in that it does not require a power amplifier to be overdimensioned, and does not introduce extra power consumption. The antenna can be used for transmitting as well as for receiving radio frequency signals. The antenna has a sufficient bandwidth, is in fact wideband, is low cost and can easily be manufactured. Preferably, the connection point(s) is(are) located near the closed end of the slot to provide a broadband antenna efficiency.

An embodiment of the device according to the invention is defined by the conductive plane comprises an area, the antenna comprising a radio module with a conductive shielding mounted on the area and electrically connected to the conductive plane. This way, the space available on the conductive plane is efficiently used by the radio module. The area for example comprises a non-conductive area.

An embodiment of the device according to the invention is defined by the radio module having a thickness for exchanging radio frequency signals in a X-direction and/or a Y-direction, in case of a Z-direction being the direction which is perpendicular to the conductive plane. Without the radio module, the radio frequency signals are (almost) not exchanged in the X-direction and/or the Y-direction.

An embodiment of the device according to the invention is defined by the slot divides the conductive plane into a first plane and a second plane, a surface of the second plane being at least 10% and at most 50% of a surface of the conductive plane, the first plane comprising the area. Smaller surfaces of the second plane reduce the antenna efficiency, larger surfaces of the second plane make the antenna too large.

An embodiment of the device according to the invention is defined by a surface of the radio module being smaller than the surface of the first plane. This way, the radio module does almost not change the matching parameters.

An embodiment of the device according to the invention is defined by the slot being a coupling and non-radiating slot mainly. The word “mainly” here means that the slot of the antenna of the device according to the invention has a coupling function of more than 50%, and a radiating function of less than 50%.

An embodiment of the device according to the invention is defined by the length of the slot being between 10% and 50% of a wavelength of the radio frequency signals. The length of the slot is a matching parameter, in an optimum case this length will be about 25% of the wavelength of the radio frequency signals. In case of the slot being a bended or folded slot, the length of the slot is the sum of the lengths of the parts of the slot.

An embodiment of the device according to the invention is defined by a distance from the connection point to a nearest side of the conductive plane in a direction perpendicular to the slot at the closed end being at least 2% of a wavelength of the radio frequency signals. Preferably, it will be about 5% to 10% of the wavelength of the radio frequency signals, to get an optimum antenna efficiency.

An embodiment of the device according to the invention is defined by the conductive plane forming part of a printed circuit board or other laminate material. This way, the printed circuit board or other laminate material has a dual function: an antenna function and a mounting function.

An embodiment of the device according to the invention is defined by the radio frequency signals having a frequency of at least 1 GHz. Preferably, the device is used for radio frequency signals at 2.4 GHz or higher.

The antenna according to the invention for exchanging radio frequency signals is defined by comprising:

a conductive plane with a slot comprising an open end and a closed end; and

a connection point located near the slot more closely to the closed end than to the open end;

which conductive plane does not operate against a ground surface, the perimeter of the conductive plane being between 50% and 200% of a wavelength of the radio frequency signals.

The method according to the invention for exchanging radio frequency signals is defined by comprising a step of using an antenna, which antenna comprises:

a conductive plane with a slot comprising an open end and a closed end; and

a connection point located near the slot more closely to the closed end than to the open end;

which conductive plane does not operate against a ground surface, the perimeter of the conductive plane being between 50% and 200% of a wavelength of the radio frequency signals.

Embodiments of the antenna according to the invention and of the method according to the invention correspond with the embodiments of the device according to the invention.

The invention is based upon an insight, inter alia, that a prior art antenna uses a ground plane which operates against a ground surface, which ground surface results in a sufficient antenna performance, but makes the antenna relatively large, and is based upon a basic idea, inter alia, that the conductive plane of the antenna does not need to be operated against a ground surface, under the condition that the perimeter of the conductive plane is between 50% and 200% of a wavelength of the radio frequency signals.

The invention solves the problem, inter alia, to provide a device comprising a relatively small antenna having a sufficient antenna performance, and is advantageous, inter alia, in that the antenna has a good antenna performance. Further, the antenna does not require a power amplifier to be overdimensioned, and does not introduce extra power consumption. The antenna can be used for transmitting as well as for receiving radio frequency signals. The antenna has a sufficient bandwidth, is in fact wideband, is low cost and can easily be manufactured.

These and other aspects of the invention will be apparent from and elucidated with reference to the embodiments(s) described hereinafter.

In the drawings:

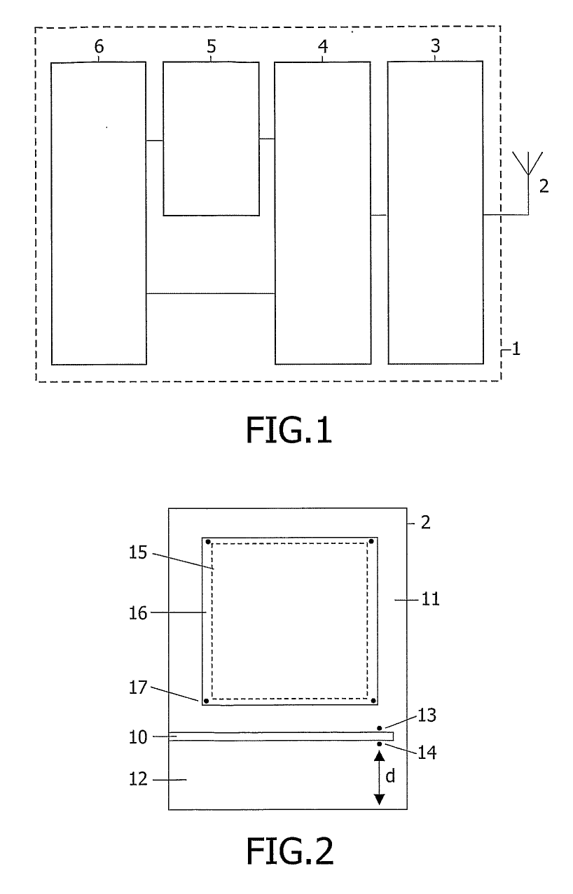

FIG. 1 shows diagrammatically a device according to the invention comprising an antenna according to the invention;

FIG. 2 shows diagrammatically an antenna according to the invention in greater detail;

FIG. 3 shows a three-dimensional view of an antenna according to the invention without a radio module being mounted;

FIG. 4 shows a three-dimensional view of an antenna according to the invention with a radio module being mounted;

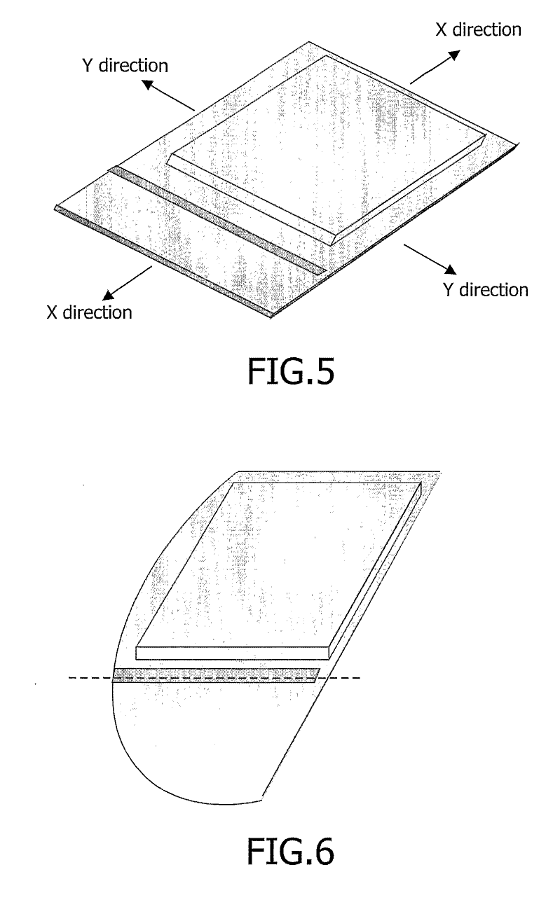

FIG. 5 shows a three-dimensional view of an antenna according to the invention with a radio module being mounted for exchanging radio frequency signals in three directions;

FIG. 6 shows a three-dimensional view of an alternative antenna according to the invention with a radio module being mounted;

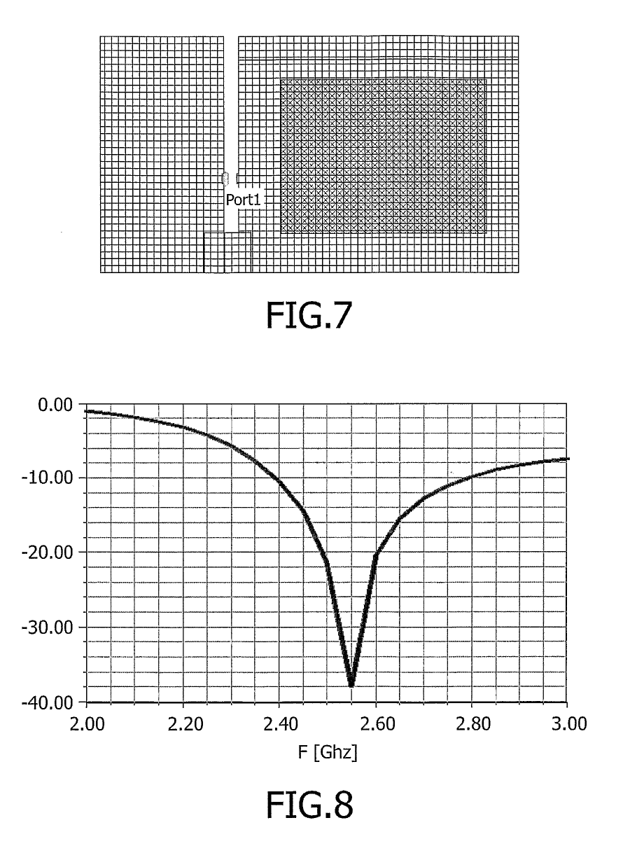

FIG. 7 shows a top view of an antenna according to the invention with a radio module being mounted;

FIG. 8 shows a simulated return loss for an antenna according to the invention;

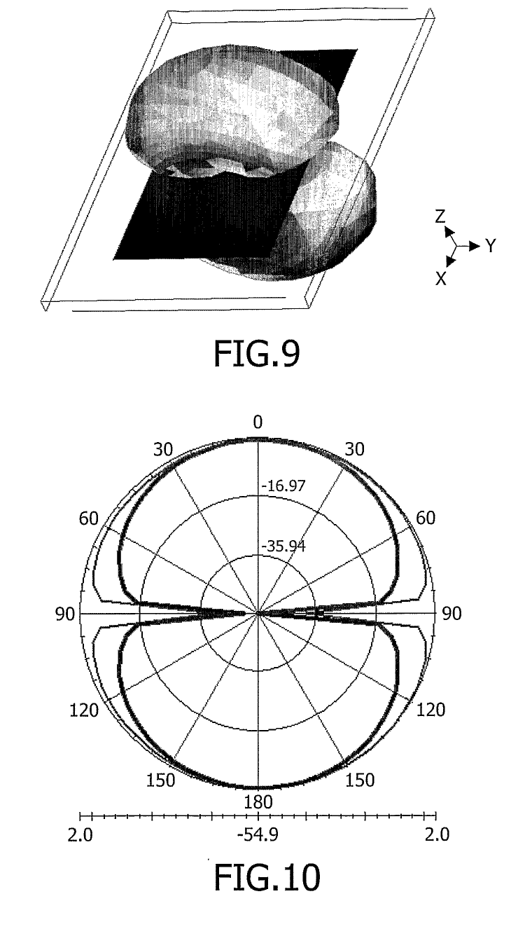

FIG. 9 shows a simulated three-dimensional radiation pattern for an antenna according to the invention;

FIG. 10 shows a simulated two-dimensional radiation pattern for an antenna according to the invention;

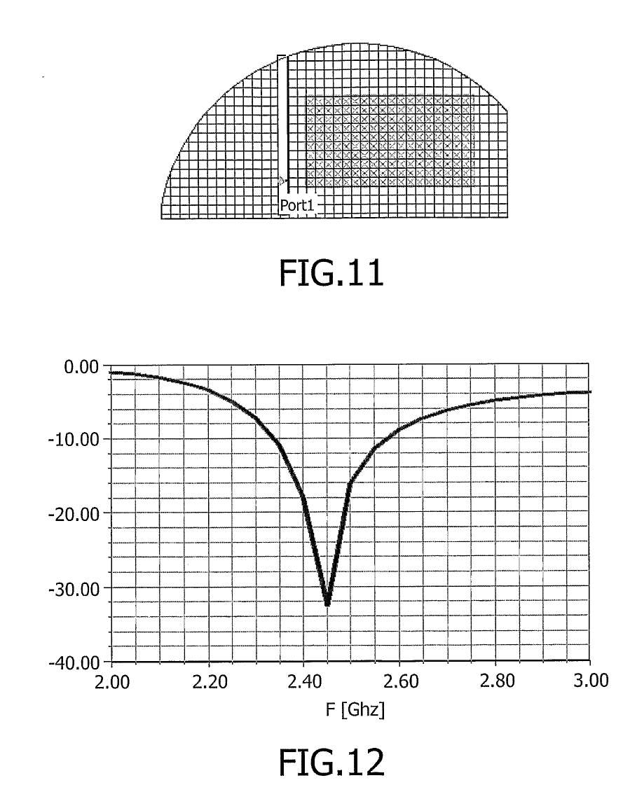

FIG. 11 shows a top view of an alternative antenna according to the invention with a radio module being mounted;

FIG. 12 shows a simulated return loss for an alternative antenna according to the invention;

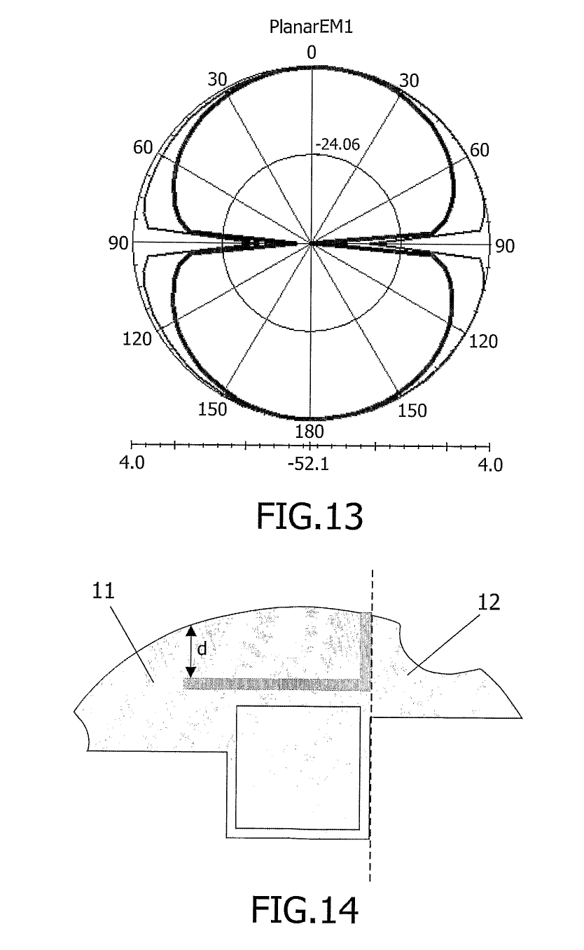

FIG. 13 shows a simulated two-dimensional radiation pattern for an alternative antenna according to the invention; and

FIG. 14 shows a top view of a further alternative antenna according to the invention with a radio module being mounted.

The device 1 according to the invention as shown in FIG. 1 such as for example a home theatre device, a surround sound device, a wireless headphone device, a second room wireless audio device, a bio-sensing device, a positioning tracking device, a mobile terminal or a wireless interface comprises an antenna 2 according to the invention coupled to a radio unit 3. The radio unit 3 is coupled to a digital signal processor 4, which is coupled to a man-machine-interface 6, indirectly via a digital-to-analog converter 5, and directly without any unit being in between.

The antenna according to the invention as shown in FIG. 2 in greater detail comprises a conductive plane 11,12 with a slot 10. The slot 10 comprises an open end and a closed end. The antenna 2 comprises connection points 13,14 located near the slot 10 more closely to the closed end than to the open end. Connection point 13 for example is a ground feeding point and connection point 14 for example is a signal feeding point.

The antenna 2 exchanges radio frequency signals with an other device not shown. The exchanging comprises receiving and/or transmitting radio frequency signals, for example radio frequency signals at 1 GHz or higher.

The antenna 2 does advantageously not operate against a ground surface. The slot 10 is a coupling and non-radiating slot mainly. The perimeter of the conductive plane 11,12 is between 50% and 200% of a wavelength of the radio frequency signals, preferably about 100%. The length of the slot 10 is between 10% and 50% of the wavelength of the radio frequency signals, preferably about 25%.

A distance “d” from the connection point(s) 13,14 to a nearest side of the conductive plane 11,12 in a direction perpendicular to the slot 10 at the closed end is at least 2% of a wavelength of the radio frequency signals, preferably about 5% to 10%.

The slot 10 divides the conductive plane 11,12 into a first plane 11 and a second plane 12. A surface of the second plane 12 is at least 10% and at most 50% of a surface of the conductive plane 11,12. The first plane 11 comprises an area 15, which is for example non-conductive, and the antenna 2 comprises a radio module 16 with a conductive shielding mounted on the area 15. This radio module 16 with the conductive shielding is electrically connected to the first plane 11 in each corner via a coupling connection 17. The radio module 16 for example corresponds with or comprises some parts of the radio module 3 shown in FIG. 1. A surface of the radio module 16 is smaller than the surface of the first plane 11. Between the connection points 13,14 and the radio module 16, a matching network may be present.

The three-dimensional view of an antenna 2 according to the invention without a radio module 16 being mounted is shown in FIG. 3, where corresponding reference signs have been used. The dashed line indicates the border between the first plane 11 (upper part) and the second plane 12 (lower part).

The three-dimensional view of an antenna 2 according to the invention with a radio module 16 being mounted is shown in FIG. 4, where corresponding reference signs have been used. The conductive plane 11,12 forms part of a printed circuit board 18 or other laminate material.

The three-dimensional view of an antenna 2 according to the invention with a radio module 16 being mounted for exchanging radio frequency signals in three directions is shown in FIG. 5. The radio module 16 has a thickness for exchanging radio frequency signals in a X-direction and/or a Y-direction, in case of a Z-direction being the direction which is perpendicular to the conductive plane 11,12.

The three-dimensional view of an alternative antenna 2 according to the invention with a radio module 16 being mounted is shown in FIG. 6. Obviously, the width of the second plane is maximal at the location of the closed end of the slot 10. Such a round antenna can be fitted easily in a round shape such as a headphone. The dashed line indicates the border between the first plane 11 (upper part) and the second plane 12 (lower part).

The top view of an antenna 2 according to the invention with a radio module 16 being mounted is shown in FIG. 7. In this case, a FR4 printed board has been used, 30×17 mm, thickness 1.6 mm, radio module 16 being 20×12 mm.

The simulated return loss for an antenna 2 according to the invention is shown in FIG. 8, dB versus GHz. The natural input impedance is matched with a broadband matching circuit to 50 Ohm, resulting in a bandwidth of about 300 MHz.

The simulated three-dimensional radiation pattern for an antenna 2 according to the invention is shown in FIG. 9.

The simulated two-dimensional radiation pattern for an antenna 2 according to the invention is shown in FIG. 10. The peak antenna gain is about 2 dbi.

The top view of an alternative antenna 2 according to the invention with a radio module 16 being mounted is shown in FIG. 11. In this case, a FR4 printed board has been used, 35×18 mm, thickness 1.2 mm, radio module 16 being 20×12 mm.

The simulated return loss for an alternative antenna 2 according to the invention is shown in FIG. 12, dB versus GHz. The natural input impedance is matched with a broadband matching circuit to 50 Ohm, resulting in a bandwidth of about 250 MHz.

The simulated two-dimensional radiation pattern for an alternative antenna 2 according to the invention is shown in FIG. 13. The peak antenna gain is about 3 dbi.

The top view of a further alternative antenna according to the invention with a radio module being mounted is shown in FIG. 14. A distance “d” from the connection point(s) 13,14 here not shown to a nearest side of the conductive plane 11,12 in a direction perpendicular to the slot 10 at the closed end is at least 2% of a wavelength of the radio frequency signals, preferably about 5% to 10%.

The dashed line indicates the border between the first plane 11 (left part) and the second plane 12 (right part). So, in general, the border between the planes 11 and 12 can be found by drawing a line through the open end of the slot 10 in parallel to the slot 10 at the open end. In case of the slot 10 being straight and not being bended or folded, the second plane 12 can be found by taking one of the two parts, the other part being the part which at least partly is to be covered by the radio module 16. In case of the slot 10 being bended or folded, the second plane 12 can be found by taking a part, which part is not enclosed or surrounded by the bended slot 10 and which part ends there where an area 15 starts, which area 15 is to be covered by the radio module 16. In case of the slot 10 being bended or folded, a length of the slot 10 is equal to the sum of the lengths of the parts of the slot 10.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements. In the device claim enumerating several means, several of these means may be embodied by one and the same item of hardware. The mere fact that certain measures are recited in mutually different dependent claims does not indicate that a combination of these measures cannot be used to advantage.

1. Device (1) comprising an antenna (2) for exchanging radio frequency signals with an other device, which antenna (2) comprises:
a conductive plane (11,12) with a slot (10) comprising an open end and a closed end; and
a connection point (13,14) located near the slot (10) more closely to the closed end than to the open end;
which conductive plane (11,12) does not operate against a ground surface, the perimeter of the conductive plane (11,12) being between 50% and 200% of a wavelength of the radio frequency signals.

2. Device (1) according to claim 1, wherein the conductive plane (11,12) comprises an area (15), the antenna (2) comprising a radio module (16) with a conductive shielding mounted on the area (15) and electrically connected (17) to the conductive plane (11,12).

3. Device (1) according to claim 2, wherein the radio module (16) has a thickness for exchanging radio frequency signals in a X-direction and/or a Y-direction, in case of a Z-direction being the direction which is perpendicular to the conductive plane (11,12).

4. Device (1) according to claim 2, wherein the slot (10) divides the conductive plane (11,12) into a first plane (11) and a second plane (12), a surface of the second plane (12) being at least 10% and at most 50% of a surface of the conductive plane (11,12), the first plane comprising the area (15).

5. Device (1) according to claim 4, wherein a surface of the radio module (16) is smaller than the surface of the first plane (11).

6. Device (1) according to claim 1, wherein the slot (10) is a coupling and non-radiating slot mainly.

7. Device (1) according to claim 1, wherein the length of the slot (10) is between 10% and 50% of a wavelength of the radio frequency signals.

8. Device (1) according to claim 1, wherein a distance (d) from the connection point (13,14) to a nearest side of the conductive plane (11,12) in a direction perpendicular to the slot (10) at the closed end is at least 2% of a wavelength of the radio frequency signals.

9. Device (1) according to claim 1, wherein the conductive plane (11,12) forms part of a printed circuit board (18) or other laminate material.

10. Device (1) according to claim 1, wherein the radio frequency signals have a frequency of at least 1 GHz.

11. Antenna (2) for exchanging radio frequency signals, which antenna (2) comprises:
a conductive plane (11,12) with a slot (10) comprising an open end and a closed end; and
a connection point (13,14) located near the slot (10) more closely to the closed end than to the open end;
which conductive plane (11,12) does not operate against a ground surface, the perimeter of the conductive plane (11,12) being between 50% and 200% of a wavelength of the radio frequency signals.

12. Method for exchanging radio frequency signals, which method comprises a step of using an antenna (2), which antenna (2) comprises:
a conductive plane (11,12) with a slot (10) comprising an open end and a closed end; and
a connection point (13,14) located near the slot (10) more closely to the closed end than to the open end;
which conductive plane (11,12) does not operate against a ground surface, the perimeter of the conductive plane (11,12) being between 50% and 200% of a wavelength of the radio frequency signals.
